(19) United States
(12) Patent Application Publication
(10) Pub. No.: US 2023/0252369 A1
(43) Pub. Date: Aug. 10, 2023

(54) INFORMATION PROCESSING DEVICE AND BUILDING MONITORING SYSTEM COMPRISING SAME

(71) Applicant: TAISHO SKY BUILDING, INC., Tokyo (JP)

(72) Inventor: Kazuharu ISHIDA, Tokyo (JP)

(21) Appl. No.: 18/301,230

(22) Filed: Apr. 15, 2023

Related U.S. Application Data
(63) Continuation of application No. PCT/JP2020/038966, filed on Oct. 15, 2020.

(51) Int. Cl. G06Q 10/02; G06V 40/20

(52) U.S. Cl. CPC G06Q 10/02; G06V 40/20

(57) ABSTRACT

An information processing device for a rental space that can increase certainty of reservation while suppressing a processing load on a management server, wherein a site controller is connected to a management server and a customer attraction server via a communication line. The customer attraction server includes a reservation manager that manages customer attraction side reservation information regarding a user and reservation date and time. The management server includes a reservation manager that manages management side reservation information regarding the user and the reservation date and time. The site controller includes a reservation manager that obtains update of the customer attraction side reservation information of the customer attraction server and update of the management side reservation information of the management server, and a synchronization controller that synchronizes the customer attraction side reservation information of the customer attraction server and the management side reservation information of the management server.

### RELATED APPLICATIONS

The present application is a continuation of International Patent Application No. PCT/JP2020/038966, filed Oct. 15, 2020, which is hereby incorporated by reference in its entirety.

### TECHNICAL FIELD

The present disclosure relates to an information processing device for setting a usage time and allowing a user to use a building, and a building monitoring system including the information processing device.

### BACKGROUND

Conventionally, a system for renting an empty conference room such as a building, an office, or a hotel to general users has been proposed. Such a rental system may include a management server open to a communication network such as the Internet and a plurality of reservation servers in which conference room information is stored, and is configured so that the users can access the conference room information in the reservation server via the management server and reserve a desired conference room. In addition, the rental system may also have a billing function so that rental fees can be paid online.

### SUMMARY

However, in conventional systems, although reservations and payments can be made in advance from the users via the communication network, it is not assumed that reservations from a plurality of customer attraction sites (customer attraction servers) are received. Therefore, if the system receives duplicate reservations with similar conditions from the customer attraction sites, a load for processing the reservations on the management server increases, and there is a problem that processing errors such as double booking may occur. It is also possible to increase processing capacity of the management server in order to cope with increase in load, but there is a problem that system configuration is complicated and the cost required for initial capital investment and maintenance increases.

An object of the present disclosure is to provide an information processing device capable of increasing certainty of reservation while suppressing the load on the management server, and a building monitoring system including the information processing device.

The information processing device of the present disclosure is an information processing device that is connected to a management server for managing information on a building and at least one customer attraction server for attracting a user of the building via a communication line, and sets a usage time and allows the user to use the building, in which the customer attraction server includes a customer attraction server side control unit that controls the customer attraction server, the customer attraction server side control unit includes a customer attraction side reservation manager that is connected to a user input unit for receiving information input to the customer attraction server via the communication line, and manages customer attraction side reservation information regarding the user received via the user input unit and reservation date and time including usage start time and usage end time set by reservation, the management server includes a management server side control unit that controls the management server, the management server side control unit includes a management side reservation manager that manages management side reservation information regarding the user and the reservation date and time including the usage start time and the usage end time set by the reservation, the information processing device includes an information processing device side control unit that controls the information processing device, and the information processing device side control unit includes: an information obtainer that obtains update of the customer attraction side reservation information of the customer attraction server and update of the management side reservation information of the management server; and a synchronization controller that synchronizes the customer attraction side reservation information of the customer attraction server and the management side reservation information of the management server on the basis of the customer attraction side reservation information and the management side reservation information obtained by the information obtainer.

With such a configuration, the information processing device is connected to the management server and the customer attraction server via the communication line, the update of the customer attraction side reservation information of the customer attraction server received via the user input unit and the update of the management side reservation information of the management server are obtained by the information obtainer, and the management side reservation information and the customer attraction side reservation information can be synchronized by the synchronization controller, so that double booking of the reservation for the building can be prevented, and certainty of the reservation is increased. Further, since the management server and the customer attraction server do not need to synchronize the reservation information with each other, the load on the servers can be suppressed.

In the present disclosure, the information processing device preferably includes a key issuer that issues an unlocking key for unlocking a locking device of the building when the update of the customer attraction side reservation information is obtained.

With such a configuration, since the information processing device includes the key issuer that issues the unlocking key for unlocking the locking device of the building on the basis of the update of the customer attraction side reservation information, it is possible to issue the unlocking key to the user even for the reservation from the customer attraction server that does not meet specifications of the locking device of the building, and to widely attract users regardless of the specifications of the customer attraction server.

The building monitoring system of the present disclosure includes: the information processing device described above; a building monitoring device that is provided inside a building and monitors an inside of the building; and the management server that is connected to the building monitoring device via the communication line and manages the building monitoring device, in which the building monitoring device includes a building monitoring device side control unit that controls the building monitoring device, the building monitoring device side control unit includes an abnormality notifier that notifies the management server of an abnormality via the communication line when the abnormality having occurred inside the building is detected, and the management server side control unit includes an abnormality annunciator that announces the abnormality to an administrator when the abnormality is notified of by the abnormality notifier.

With such a configuration, the building monitoring device side control unit includes an abnormality notifier that notifies the management server of the abnormality via the communication line when the abnormality having occurred inside the building is detected, and the management server side control unit includes the abnormality annunciator that announces the abnormality to an administrator when it is notified of the abnormality by the abnormality notifier, so that the administrator can easily grasp the abnormality such as damage inside the building even when the building is used without the presence of the agent. Therefore, according to the building monitoring system of the present disclosure, it is possible to monitor the building unattended without requiring the presence of the agent and suppress the damage or the like inside the building.

In the present disclosure, it is preferred that the building monitoring device is connected to a locking device of the building via a communication line, and the building monitoring device side control unit includes a locking device determiner that determines whether the locking device has been normally unlocked, and detects the abnormality having occurred inside the building when the locking device determiner has determined that the locking device has not been normally unlocked.

With such a configuration, the building monitoring device side control unit includes the locking device determiner that determines whether the locking device has been normally unlocked, and detects the abnormality having occurred inside the building when the locking device determiner has determined that the locking device has not been normally unlocked, so that unlike a user, for example, who can unlock the locking device normally, that is, a user authorized by the administrator, intrusion of an unauthorized person using an illegal means such as picking can be detected as the abnormality by the locking device determiner, and safety of the building can be improved.

In the present disclosure, it is preferred that the building monitoring device includes a customer service unit that serves a user of the building, and the building monitoring device side control unit includes a customer service executor that executes customer service by the customer service unit when the locking device determiner determines that the locking device is normally unlocked.

With such a configuration, the building monitoring device side control unit includes the customer service executor that executes customer service by the customer service unit when the locking device determiner determines that the locking device is normally unlocked, so that it is possible to execute customer service by the customer service unit to the user who can unlock the locking device normally, that is, the user authorized by the administrator. Here, examples of contents of the customer service by the customer service unit include that selling points of the building are explained to the user, selling points of products and the like are explained to the user in the case of a store that displays the products and the like in the building, the user is guided to look around the inside of the building, and lighting and an air conditioner installed in the building are operated.

In the present disclosure, it is preferred that the building monitoring device includes an image capturing unit that captures an image of the inside of the building, and the building monitoring device side control unit includes: a storage that stores a sample of a normal behavior pattern of a user of the building; a behavior pattern obtainer that obtains the behavior pattern of the user of the building on the basis of the image captured by the image capturing unit; and a behavior pattern determiner that compares the sample of the behavior pattern stored in the storage with the behavior pattern obtained by the behavior pattern obtainer, determines whether there is a difference, and detects the abnormality having occurred inside the building when the behavior pattern determiner has determined that there is the difference.

With such a configuration, the building monitoring device side control unit includes the behavior pattern determiner that compares the sample of the normal behavior pattern of the user of the building with the behavior pattern obtained by the behavior pattern obtainer, determines whether there is a difference, and detects the abnormality having occurred inside the building when the behavior pattern determiner has determined that there is the difference, so that for example, by memorizing in the storage as the normal behavior pattern the behavior pattern conforming to a normal user such as looking around the inside of the building, it is possible to detect by the behavior pattern determiner as the abnormality an intruder with a suspicious behavior pattern such as looking for the inside of the building, and to improve the safety of the building.

In the present disclosure, it is preferred that the building monitoring device includes an image capturing unit that captures an image of the inside of the building, and the building monitoring device side control unit includes: a storage that stores a sample of an abnormal behavior pattern of a user of the building; a behavior pattern obtainer that obtains the behavior pattern of the user of the building on the basis of the image captured by the image capturing unit; and a behavior pattern determiner that compares the sample of the behavior pattern stored in the storage with the behavior pattern obtained by the behavior pattern obtainer, determines whether the sample of the behavior pattern and the obtained behavior pattern match, and detects the abnormality having occurred inside the building when the behavior pattern determiner has determined that the sample of the behavior pattern and the obtained behavior pattern match.

With such a configuration, the building monitoring device side control unit includes the behavior pattern determiner that compares the sample of the abnormal behavior pattern of the user of the building with the behavior pattern obtained by the behavior pattern obtainer, determines whether the sample of the abnormal behavior pattern and the obtained behavior pattern match, and detects the abnormality having occurred inside the building when the behavior pattern determiner has determined that the sample of the abnormal behavior pattern and the obtained behavior pattern match, so that for example, by memorizing in the storage as the abnormal behavior pattern the suspicious behavior pattern such as looking for the inside of the building, it is possible to detect the intruder with the suspicious behavior pattern as the abnormality by the behavior pattern determiner, and to improve the safety of the building.

In the present disclosure, it is preferred that the management server side control unit includes: a management side reservation manager that manages management side reservation information including usage start time and usage end time set by reservation; a command generator that generates a command to the building monitoring device on the basis of the management side reservation information; and a command transmitter that transmits the command to the building monitoring device via the communication line, and the building monitoring device side control unit includes: a command receiver that receives the command from the command transmitter; and a command executor that executes a predetermined operation on the basis of the command received by the command receiver.

With such a configuration, the building monitoring device side control unit includes: the command receiver that receives the command from the command transmitter; and the command executor that executes the predetermined operation on the basis of the command received by the command receiver, so that it is possible to reach out to the user who is looking around the inside of the building by executing an operation based on an appropriate command. Therefore, for example, the building monitoring device can suppress time excess of usage by announcing the usage end time to the user, set free time until reservation of a next user to be short, and improve efficiency of using the building.

In the present disclosure, it is preferred that the command generator generates an announcement command to announce the usage end time on the basis of the management side reservation information, and the command executor announces the usage end time to a user on the basis of the announcement command.

With such a configuration, the command executor announces the usage end time to the user on the basis of the announcement command, so that the building monitoring device can suppress the time excess of the usage by announcing the usage end time to the user, set free time until reservation of the next user to be short, and improve efficiency of using the building.

In the present disclosure, it is preferred that the management side reservation manager manages the management side reservation information including a reservation status after the usage end time, the command generator generates an extension command to announce whether the usage time can be extended according to the reservation status on the basis of the management side reservation information, and the command executor announces to a user whether the usage time can be extended on the basis of the extension command.

With such a configuration, the command executor announces to the user whether the usage time can be extended on the basis of the extension command, so that it is possible to announce to the user that the usage time can be extended when there is free time in the reservation after the usage end time. In addition, when there is no free time in the reservation after the usage end time, it is possible to announce to the user that the usage time cannot be extended.

In the present disclosure, it is preferred that the building monitoring device includes an input receiving unit that receives input of an application for extension by a user, the building monitoring device side control unit includes an application transmitter that transmits the application for extension to the management server via the communication line when the input of the application for extension is received by the input receiving unit, the management server side control unit includes an application receiver that receives the application for extension transmitted from the application transmitter, and the management side reservation manager changes the usage end time and updates the management side reservation information on the basis of the application for extension received by the application receiver.

With such a configuration, the management server side control unit includes the application receiver that receives the application for extension transmitted from the application transmitter, and the management side reservation manager changes the usage end time and updates the management side reservation information on the basis of the application for extension received by the application receiver, so that the usage time can be extended on the basis of the application for extension by the user.

In the present disclosure, it is preferred that the building monitoring device includes a presence detection unit that detects presence of a user inside the building, the building monitoring device side control unit includes a presence notifier that notifies the management server of the presence of the user via the communication line when the presence detection unit detects the presence of the user, the management server side control unit includes a presence manager that manages presence information of the user notified by the presence notifier, the command generator generates a warning command to announce a warning to the user when the user is present even after the usage end time on the basis of the management side reservation information and the presence information, and the command executor announces to the user that the usage end time has passed on the basis of the warning command.

With such a configuration, the command generator generates the warning command to announce the warning to the user when the user is present even after the usage end time on the basis of the management side reservation information and the presence information, and the command executor announces to the user that the usage end time has passed on the basis of the warning command, so that it is possible to reliably announce the time excess of the usage to the user.

### BRIEF DESCRIPTION OF THE DRAWINGS

FIG. 1 is a schematic configuration diagram of a building monitoring system including an information processing device according to an embodiment of the present disclosure.

FIG. 2 is a functional block diagram illustrating a preview robot and a management server in a schematic configuration of the building monitoring system.

FIG. 3 is a flowchart illustrating an operation of the building monitoring system.

FIG. 4 is a flowchart illustrating behavior pattern determination processing.

FIG. 5 is a flowchart illustrating extension announcement processing.

FIG. 6 is a flowchart illustrating warning processing.

FIG. 7 is a functional block diagram illustrating a management server, a customer attraction server, and a site controller in the schematic configuration of the building monitoring system.

FIG. 8 is a flowchart illustrating operations of the management server, the customer attraction server, and the site controller.

### DETAILED DESCRIPTION

Hereinafter, an embodiment of the present disclosure will be described with reference to the drawings.

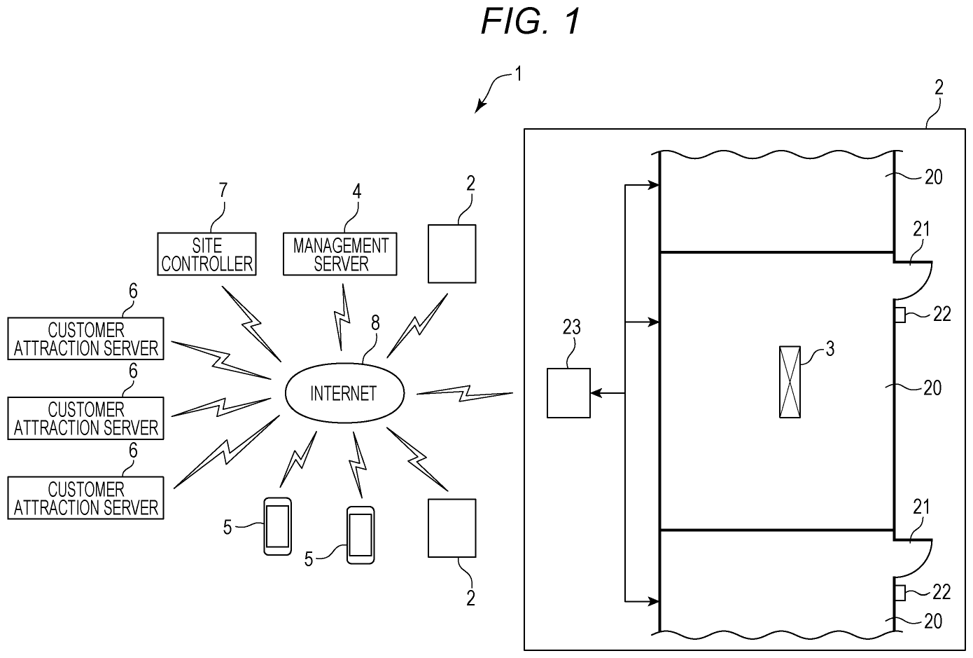

FIG. 1 is a schematic configuration diagram of a building monitoring system including an information processing device according to the embodiment of the present disclosure.

As illustrated in FIG. 1, a building monitoring system 1 includes a preview robot 3 placed inside a building 2, a management server 4 for managing the building 2 and the preview robot 3, a terminal device 5 as a user input unit such as a mobile phone, a smartphone, or a personal computer possessed by a previewer (user) who wishes to preview (use) the building 2, a plurality of customer attraction servers 6 for attracting the previewer and for reserving a preview of the building 2, and a site controller 7 (an information processing device) for synchronizing reservation information between the management server 4 and the customer attraction servers 6. The building 2, the preview robot 3, the management server 4, the terminal device 5, the customer attraction servers 6, and the site controller 7 are connected to each other so as to be able to communicate with each other via the Internet 8 that is a public network as a communication line.

The building 2 includes a plurality of rooms 20, and each room 20 includes a doorway 21 and a locking device 22 for locking and unlocking the doorway 21. The locking device 22 can be unlocked by an unlocking key such as a password or an optical code such as a bar code or a QR code (registered trademark) issued from the site controller 7 to the terminal device 5 of the previewer. The unlocking key is randomly changed each time it is used, and the previewer who makes a reservation for that time can unlock the locking device 22 by using a unique unlocking key. Each room 20 includes a communication terminal device 23 such as a modem or a router connected via a local area network (LAN). The communication terminal device 23 is connected to the management server 4 via the Internet 8.

Here, the management server 4 manages a plurality of buildings 2 and meets specifications of the locking device 22 of the room 20 in each building 2. The site controller 7 also meets the specifications of the locking device 22 of the room 20 in each building 2 managed by the management server 4. In other words, the site controller 7 can issue the unlocking key corresponding to the locking device 22 of the room 20 in each building 2.

In the present embodiment, a password, a bar code, or the like is employed as the unlocking key, but for example, biometric authentication such as face authentication, fingerprint authentication, or retinal authentication may be employed, and any unlocking key may be employed as long as it can unlock the locking device 22.

Further, the site controller 7 may be capable of synchronizing the reservation information between a plurality of the management servers 4 and the customer attraction servers 6.

The preview robot 3 is a transportable device that is configured to be placeable inside the building 2 and has transportability. The preview robot 3 is carried into the building 2 by a real estate brokerage agent who manages the building 2 when the building 2 is previewed. Further, when a tenant contract is concluded for the building 2, the preview robot 3 is removed from inside the building 2 by the real estate brokerage agent who manages the building 2.

Since the preview robot 3 is configured to be placeable inside the building 2 and has transportability, it can be placed in the building 2 desired for preview before the preview, and when the tenant contract is concluded, the preview robot 3 can be easily removed.

Although the preview robot 3 has transportability in the present embodiment, it does not have to be transportable and may be placed in advance inside the building 2.

The previewer can access the management server 4 or the customer attraction server 6 via the Internet 8 using the terminal device 5, search for the room 20 desired for the preview, and make a reservation for the preview by specifying a usage time. Upon receiving the reservation from the previewer, the management server 4 or the customer attraction server 6 transmits the reservation information including the previewer and reservation date and time (usage start time and usage end time) of the room 20 for which the reservation has been confirmed to the site controller 7.

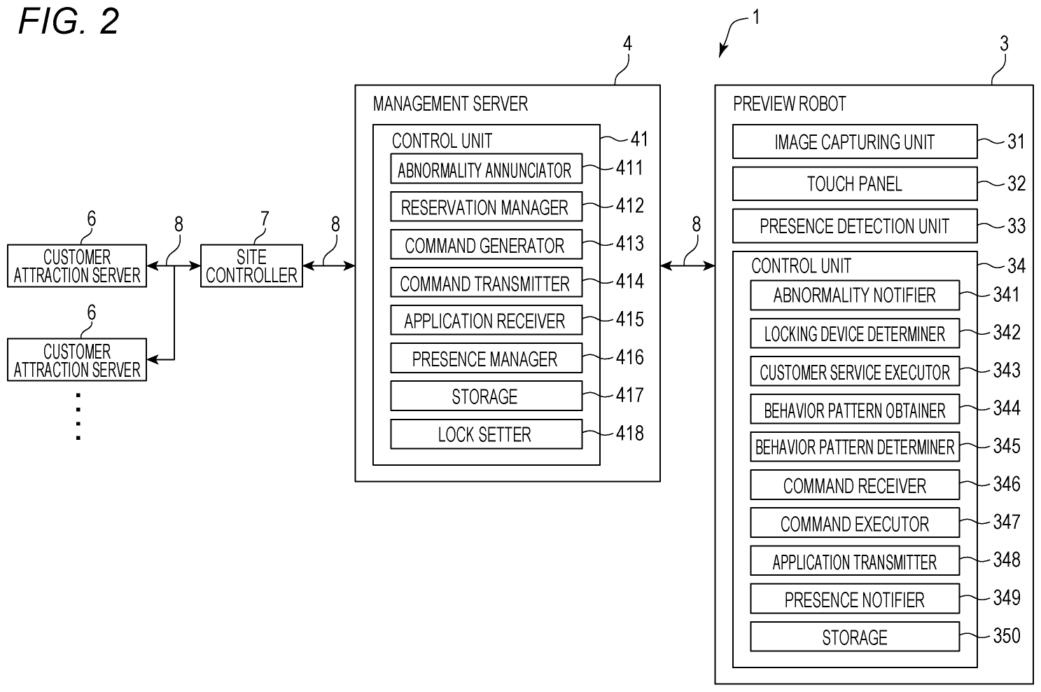

FIG. 2 is a functional block diagram illustrating the preview robot and the management server in a schematic configuration of the building monitoring system.

The preview robot 3 functions as the building monitoring device for monitoring an inside of the building 2, and as illustrated in FIG. 2, includes an image capturing unit 31, a touch panel 32, a presence detection unit 33, and a control unit 34 as a building monitoring device side control unit.

The image capturing unit 31 captures an image of an inside of the room 20. As the image capturing unit 31, for example, a charge coupled device (CCD) camera or the like can be employed.

The touch panel 32 receives an input of information according to an operation of the previewer and provides predetermined information as the image to the previewer.

The presence detection unit 33 detects presence of the previewer inside the room 20. As the presence detection unit 33, for example, a motion sensor or the like can be employed, and in addition, the presence of the previewer may be detected by using the image captured by the image capturing unit 31.

The control unit 34 includes a central processing unit (CPU), a memory, and the like, and executes information processing according to a predetermined program stored in the memory. The control unit 34 includes an abnormality notifier 341, a locking device determiner 342, a customer service executor 343, a behavior pattern obtainer 344, a behavior pattern determiner 345, a command receiver 346, and a command executor 347, an application transmitter 348, a presence notifier 349, and a storage 350.

Here, the storage 350 stores in advance a plurality of samples of normal behavior pattern of the previewer of the room 20. Specifically, the storage 350 stores as the normal behavior pattern a behavior pattern conforming to a normal preview such as looking around the inside of the building.

Note that in the present embodiment, the storage 350 includes a memory of the control unit 34, but may include a hard disk drive (HDD), a network attached storage (NAS), or the like, and may include a cloud service.

Further, although functions of the control unit 34 are executed according to a program stored in the storage 350, each function may be implemented by an independent device or may be implemented by cloud computing.

Upon detecting an abnormality having occurred inside the room 20, the abnormality notifier 341 notifies the management server 4 of the abnormality via the Internet 8. The locking device determiner 342 determines whether the locking device 22 has been normally unlocked, and detects the abnormality having occurred inside the room 20 when the locking device determiner has determined that the locking device 22 has not been normally unlocked.

When the locking device determiner 342 determines that the locking device 22 is normally unlocked, the customer service executor 343 executes customer service using the touch panel 32. Specifically, the control unit 34 displays selling points of the room 20 on a display screen of the touch panel 32, and starts explanation to the previewer.

In this way, the touch panel 32 functions as a customer service unit that serves to the previewer of the room 20.

Note that in the present embodiment, the touch panel 32 is employed as the customer service unit, but only voice may be employed, and for example, in the case of a store displaying products or the like in the room 20, selling points of the products may be explained to the user, a moving unit capable of freely moving in the room 20 may be attached to the preview robot 3 to guide the previewer to look around the inside of the room 20, and lighting and an air conditioner installed in the room 20 may be connected via a communication line to be automatically operated. Further, the customer service unit may have a settlement function for allowing the user to purchase the products or the like in the case of the store displaying the products or the like in the room 20. In conclusion, any customer service unit may be employed as long as it can serve the previewer of the building.

The behavior pattern obtainer 344 obtains the behavior pattern of the previewer of the room 20 on the basis of the image captured by the image capturing unit 31.

The behavior pattern determiner 345 compares the plurality of samples of the behavior pattern stored in the storage 350 with the behavior pattern obtained by the behavior pattern obtainer 344, determines whether the samples of the behavior pattern and the obtained behavior pattern differ, and if the behavior pattern determiner has determined that the samples of the behavior pattern and the obtained behavior pattern differ, detects the abnormality generated inside the room 20.

As described above, in the present embodiment, when the locking device determiner 342 detects the abnormality having occurred inside the room 20, or when the behavior pattern determiner 345 detects the abnormality having occurred inside the room 20, the abnormality notifier 341 notifies the management server 4 of the abnormality via the Internet 8.

On the other hand, for example, a sound collecting unit such as a microphone may collect sounds inside the room 20, and it may be determined whether damage or the like inside the room 20 has occurred on the basis of the collected sounds, and when it is determined that the damage or the like inside the room 20 has occurred, the abnormality having occurred inside the room 20 may be detected. In conclusion, when the abnormality having occurred inside the building is detected, the abnormality notifier is only required to be able to notify the management server of the abnormality via the communication line.

The command receiver 346 receives a command from the management server 4.

The command executor 347 executes a predetermined operation on the basis of the command received by the command receiver 346. The predetermined operation will be described in detail below.

The application transmitter 348 transmits an application for extension of a preview time (usage time) by the previewer to the management server 4. Specifically, upon receiving the input of the application for extension by the previewer via the touch panel 32, the application transmitter 348 transmits the application for extension to the management server 4 via the Internet 8.

When the presence detection unit 33 detects the presence of the previewer, the presence notifier 349 notifies the management server 4 of the presence of the previewer via the Internet 8.

The management server 4 includes a control unit 41 as a management server side control unit.

The control unit 41 includes the CPU, the memory, and the like, and executes information processing according to the predetermined program stored in the memory. The control unit 41 includes an abnormality annunciator 411, a reservation manager 412 as a management side reservation manager, a command generator 413, a command transmitter 414, an application receiver 415, a presence manager 416, a storage 417, and a lock setter 418.

The abnormality annunciator 411 announces the abnormality to the administrator when it is notified of the abnormality by the abnormality notifier 341. Specifically, the abnormality annunciator 411 announces the abnormality to the administrator via a display device (not illustrated) connected to the management server 4.

The reservation manager 412 causes the storage 417 to store the management side reservation information including preview start time (usage start time) and preview end time (usage end time) set by the reservation, and manages the management side reservation information.

The command generator 413 generates a command to the preview robot 3 on the basis of the management side reservation information. Specifically, the command generator 413 generates various commands such as an announcement command to announce the preview end time, an extension command to announce whether the preview time can be extended according to a reservation status, and a warning command to announce a warning to the previewer when the previewer is present even after the preview end time.

The command transmitter 414 transmits the command to the preview robot 3 via the Internet 8.

The application receiver 415 receives the application for extension transmitted from the application transmitter 348 of the preview robot 3. Then, the reservation manager 412 changes the preview end time and updates the management side reservation information, on the basis of the application for extension received by the application receiver 415.

The presence manager 416 causes the storage 417 to store presence information of the previewer notified by the presence notifier 349, and manages the presence information.

Note that the storage 417 includes the memory of the control unit 41, but may include the HDD, the NAS, or the like, and may include the cloud service.

Further, although functions of the control unit 41 are executed according to a program stored in the storage 417, each function may be implemented by the independent device or may be implemented by cloud computing.

The lock setter 418 sets the locking device 22 of the room 20.

Specifically, the lock setter 418 sets the unlocking key corresponding to the management side reservation information to the locking device 22 of the room 20, when the preview start time included in the management side reservation information is reached, or shortly before the preview start time (for example, 10 minutes before the preview start time).

Further, the lock setter 418 sets an unlocking key different from the unlocking key corresponding to the management side reservation information to the locking device 22 of the room 20, when the preview end time included in the management side reservation information has passed, or shortly after the preview end time (for example, 10 minutes after the preview end time).

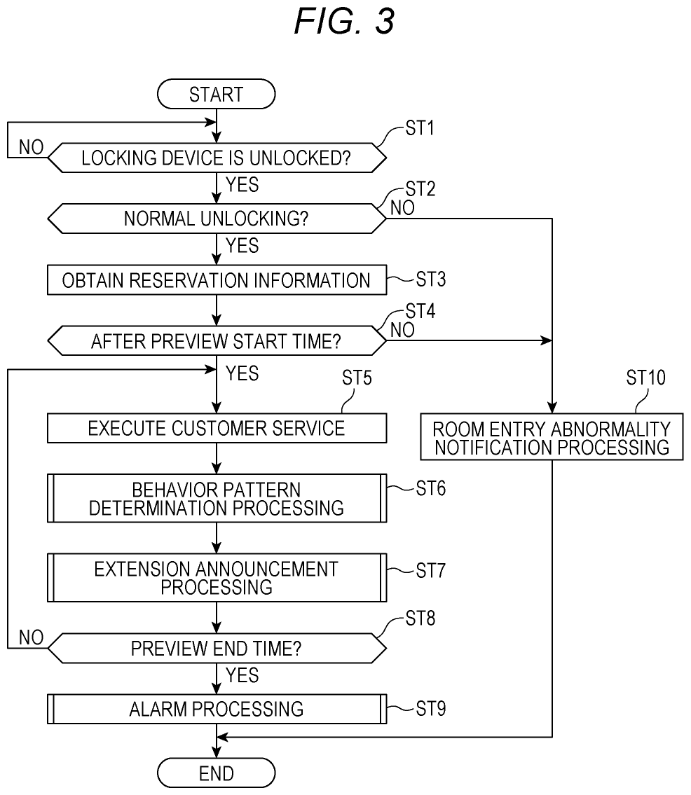

FIG. 3 is a flowchart illustrating the operation of the building monitoring system.

The building monitoring system 1 executes processing of Steps ST1 to 10 as illustrated in FIG. 3 according to the predetermined program stored in the memory.

Note that in FIG. 3, the operation of the preview robot 3 and the operation of the management server 4 are collectively referred to as the operation of the building monitoring system 1, and this will be described using a common flowchart.

First, the locking device determiner 342 of the preview robot 3 determines whether the locking device 22 has been unlocked (Step ST1).

If it is determined in Step ST1 that the locking device 22 is not unlocked, the locking device determiner 342 repeatedly executes the processing in Step ST1.

On the other hand, when it is determined in Step ST1 that the locking device 22 has been unlocked, the locking device determiner 342 determines whether the locking device 22 has been normally unlocked (Step ST2).

When it is determined in Step ST2 that the locking device 22 is not normally unlocked, the control unit 34 executes room entry abnormality notification processing in Step ST10 to be described below. The room entry abnormality notification processing in Step ST10 will be described in detail below.

On the other hand, when it is determined in Step ST2 that the locking device 22 has been normally unlocked, the locking device determiner 342 makes an inquiry to the management server 4 via the Internet 8, and obtains the management side reservation information from the storage 417 of the management server 4 (Step ST3).

Here, the management side reservation information stored in the storage 417 of the management server 4 includes the preview start time and the preview end time set by reservation of the previewer, and is stored and managed in the storage 417 by the reservation manager 412.

After obtaining the management side reservation information from the storage 417 of the management server 4, the control unit 34 determines whether a time when the locking device 22 is normally unlocked is after the preview start time on the basis of the management side reservation information (Step ST4).

If it is determined in Step ST4 that it is not after the preview start time, the control unit 34 executes the room entry abnormality notification processing in Step ST10 to be described below. The room entry abnormality notification processing in Step ST10 will be described in detail below.

On the other hand, when it is determined in Step ST4 that it is after the preview start time, that is, when the locking device determiner 342 determines that the locking device 22 is normally unlocked after the preview start time, the customer service executor 343 executes customer service by the touch panel 32 (Step ST5: customer service execution processing). Specifically, the control unit 34 displays the selling points of the room 20 on the display screen of the touch panel 32, and starts explaining to the previewer.

Further, the control unit 34 executes behavior pattern determination processing in Step ST6 after starting the customer service execution processing, and executes extension announcement processing in Step ST7.

Note that the behavior pattern determination processing in Step ST6 and the extension announcement processing in Step ST7 will be described in detail below.

After executing the extension announcement processing in Step ST7, the control unit 34 determines whether the current time is after the preview end time (Step ST8).

If it is determined in Step ST8 that it is not after the preview end time, the control unit 34 repeatedly executes the processing after Step ST5 described above.

On the other hand, if it is determined in Step ST8 that it is after the preview end time, the control unit 34 executes alarm processing in Step ST9.

Note that the alarm processing in Step ST9 will be described in detail below.

Further, when it is determined in Step ST2 that the locking device 22 is not normally unlocked, or when it is determined in Step ST4 that it is not after the preview start time, the control unit 34 executes the room entry abnormality notification processing in Step ST10 as described above. In other words, when the control unit 34 detects the abnormality having occurred inside the room 20, the control unit 34 executes the room entry abnormality notification processing in Step ST10.

In the room entry abnormality notification processing in Step ST10, the abnormality notifier 341 notifies the management server 4 of the abnormality via the Internet 8.

Then, the abnormality annunciator 411 of the management server 4 announces the abnormality to the administrator when it is notified of the abnormality by the abnormality notifier 341. Specifically, the abnormality annunciator 411 announces the abnormality to the administrator via the display device (not illustrated) connected to the management server 4.

### Behavior Pattern Determination Processing

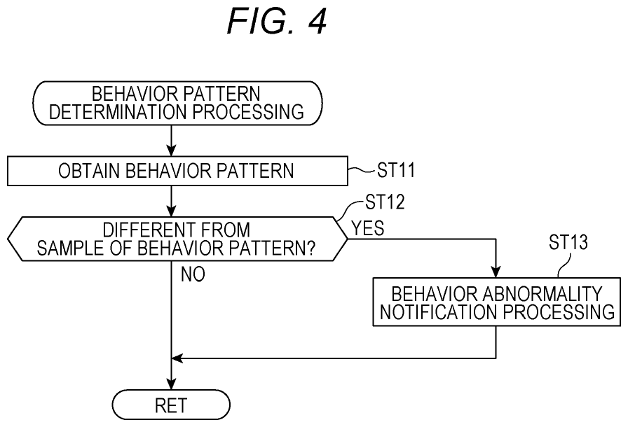

FIG. 4 is a flowchart illustrating the behavior pattern determination processing.

The control unit 34 executes the behavior pattern determination processing of Steps ST11 to ST13 as illustrated in FIG. 4 according to the predetermined program stored in the memory.

In the behavior pattern determination processing, the behavior pattern obtainer 344 obtains the behavior pattern of the previewer in the room 20 on the basis of the image captured by the image capturing unit 31 (Step ST11).

After obtaining the behavior pattern of the previewer in the room 20 in Step ST11, the behavior pattern determiner 345 compares the plurality of samples of the behavior pattern stored in the storage 350 with the behavior pattern obtained by the behavior pattern obtainer 344, and determines whether the plurality of samples and the obtained behavior pattern differ (Step ST12).

If it is determined that the plurality of samples and the obtained behavior pattern do not differ in Step ST12, the control unit 34 ends the behavior pattern determination processing.

On the other hand, if it is determined that the plurality of samples and the obtained behavior pattern differ in Step ST12, the control unit 34 executes behavior abnormality notification processing in Step ST13. In other words, when the control unit 34 detects the abnormality having occurred inside the room 20, the control unit 34 executes the behavior abnormality notification processing in Step ST13.

In the behavior abnormality notification processing in Step ST13, the abnormality notifier 341 notifies the management server 4 of the abnormality via the Internet 8.

Then, the abnormality annunciator 411 of the management server 4 announces the abnormality to the administrator when it is notified of the abnormality by the abnormality notifier 341. Specifically, the abnormality annunciator 411 announces the abnormality to the administrator via the display device (not illustrated) connected to the management server 4.

### Extension Announcement Processing

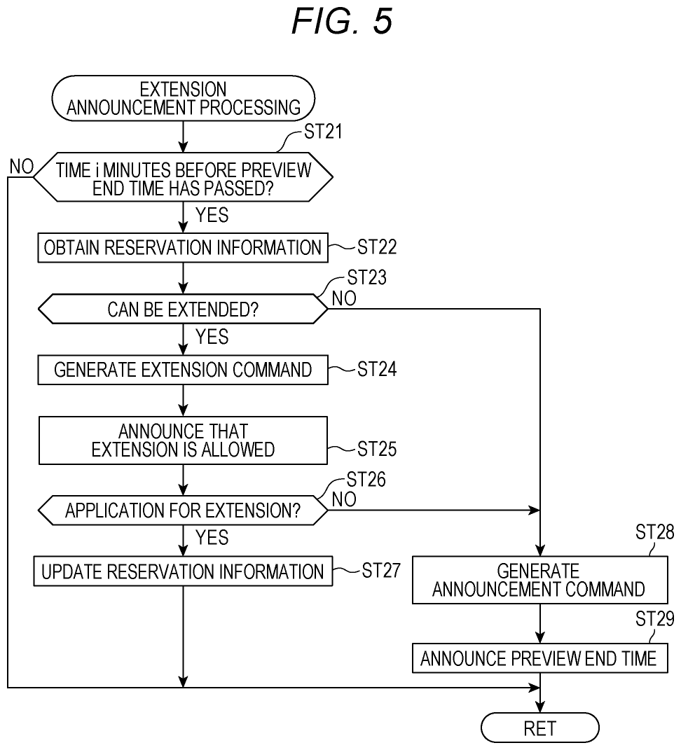

FIG. 5 is a flowchart illustrating the extension announcement processing.

The control unit 41 of the management server 4 executes the extension announcement processing of Steps ST21 to ST29 as illustrated in FIG. 5 according to the predetermined program stored in the memory.

In the extension announcement processing, the control unit 41 determines whether a predetermined time i minutes (a time set by the administrator, for example, 10 minutes) before the preview end time has passed (Step ST21).

When it is determined that the time has passed in Step ST21, the control unit 41 obtains the management side reservation information from the storage 417 (Step ST22).

After obtaining the management side reservation information from the storage 417, the control unit 41 checks whether there is free time for a predetermined time (for example, 30 minutes) or more after the preview end time on the basis of the management side reservation information, and determines whether the preview time can be extended (Step ST23).

When it is determined that the preview time can be extended in Step ST23, the command generator 413 generates the command to the preview robot 3 on the basis of the management side reservation information. Specifically, the command generator 413 generates the extension command for announcing whether the preview time can be extended according to the reservation status (Step ST24). More specifically, the command generator 413 generates, as the extension command, availability information that “the preview time can be extended” as the information that the preview time can be extended, and extension time information that “it can be extended up to 2 hours” as a time that can be extended.

Then, the command transmitter 414 transmits the extension command to the preview robot 3 via the Internet 8.

Thereafter, the command receiver 346 of the preview robot 3 receives the extension command from the management server 4.

Then, the command executor 347 executes the predetermined operation on the basis of the extension command received by the command receiver 346. Specifically, the command executor 347 displays information that “the preview time can be extended”, “it can be extended up to 2 hours”, and “please apply for extension from the screen if desired” on the display screen of the touch panel 32, to announce to the previewer (Step ST25).

After announcing to the previewer that the preview time can be extended, the control unit 34 determines whether the input of the application for extension by the previewer has been received via the touch panel 32 (Step ST26).

If it is determined in Step ST26 that the input of the application for extension by the previewer has been received, the application transmitter 348 transmits the application for extension of the preview time by the previewer to the management server 4. In other words, when the application transmitter 348 receives the input of the application for extension by the previewer via the touch panel 32, the application transmitter 348 transmits the application for extension to the management server 4 via the Internet 8. Therefore, in the present embodiment, the touch panel 32 functions as the input receiving unit for receiving the input of the application for extension by the previewer.

When the application transmitter 348 transmits the application for extension, the application receiver 415 of the management server 4 receives the application for extension transmitted from the application transmitter 348 of the preview robot 3. Then, the reservation manager 412 changes the preview end time and updates the management side reservation information, on the basis of the application for extension received by the application receiver 415 (Step ST27). Thereafter, the preview robot 3 and the management server 4 end the extension announcement processing.

On the other hand, when it is determined in Step ST26 that the input of the application for extension by the previewer is not received (when the previewer selects not to extend the preview time, when an operation of the touch panel 32 is not detected within a predetermined time, or the like), the application transmitter 348 transmits an application for non-extension to the management server 4 instead of the application for extension of the preview time by the previewer.

When the application for non-extension is transmitted by the application transmitter 348, the application receiver 415 of the management server 4 receives the application for non-extension transmitted from the application transmitter 348 of the preview robot 3. Then, the command generator 413 generates the command to the preview robot 3 on the basis of the management side reservation information. Specifically, the command generator 413 generates the announcement command for announcing the preview end time (Step ST28).

Then, the command transmitter 414 transmits the announcement command to the preview robot 3 via the Internet 8.

Thereafter, the command receiver 346 of the preview robot 3 receives the announcement command from the management server 4.

Then, the command executor 347 executes the predetermined operation on the basis of the announcement command received by the command receiver 346. Specifically, the command executor 347 displays information that “i minutes remaining until the preview end time” on the display screen of the touch panel 32, and announces the preview end time to the previewer (Step ST29). Thereafter, the preview robot 3 and the management server 4 end the extension announcement processing.

Note that as a means that announces the preview end time to the previewer, for example, an alarm may be sounded to announce to the previewer, or the preview end time may be announced to the previewer by gradually dimming lighting of the room 20, in addition to announcing the preview end time by displaying on the display screen of the touch panel 32.

### Warning Processing

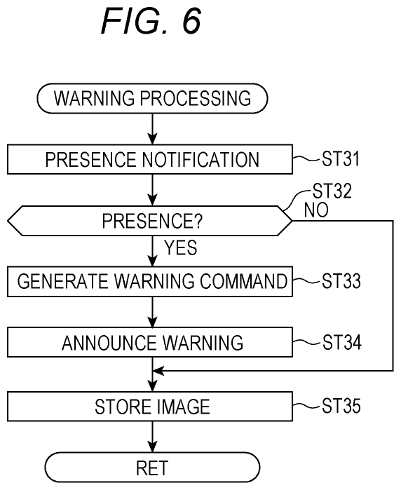

FIG. 6 is a flowchart illustrating warning processing.

The control unit 41 of the management server 4 executes the warning processing of Steps ST31 to ST35 as illustrated in FIG. 6 according to the predetermined program stored in the memory.

In the warning processing, when the presence of the previewer is detected by the presence detection unit 33, the presence notifier 349 of the preview robot 3 notifies the management server 4 of the presence of the previewer via the Internet 8 (Step ST31).

When the management server 4 is notified of the presence of the previewer via the Internet 8 in Step ST31, the presence manager 416 of the management server 4 causes the storage 417 to store the presence information of the previewer notified by the presence notifier 349, and manages the presence information.

Then, the control unit 41 of the management server 4 determines whether the previewer is present in the room 20 after the preview end time on the basis of the presence information stored in the storage 417 (Step ST32).

When it is determined in Step ST32 that the previewer is present in the room 20 after the preview end time, the command generator 413 generates the command to the preview robot 3 on the basis of the management side reservation information. Specifically, the command generator 413 generates the warning command for announcing the warning to the previewer (Step ST33).

Then, the command transmitter 414 transmits the warning command to the preview robot 3 via the Internet 8.

Thereafter, the command receiver 346 of the preview robot 3 receives the warning command from the management server 4.

Then, the command executor 347 executes the predetermined operation on the basis of the warning command received by the command receiver 346. Specifically, the command executor 347 displays information that “the preview end time has passed” on the display screen of the touch panel 32 to announce to the previewer that the preview end time has passed (Step ST34). Further, the command executor 347 captures the image of the inside of the room 20 by the image capturing unit 31 and stores it in the storage 350 (Step ST35). Thereafter, the preview robot 3 and the management server 4 end the extension announcement processing.

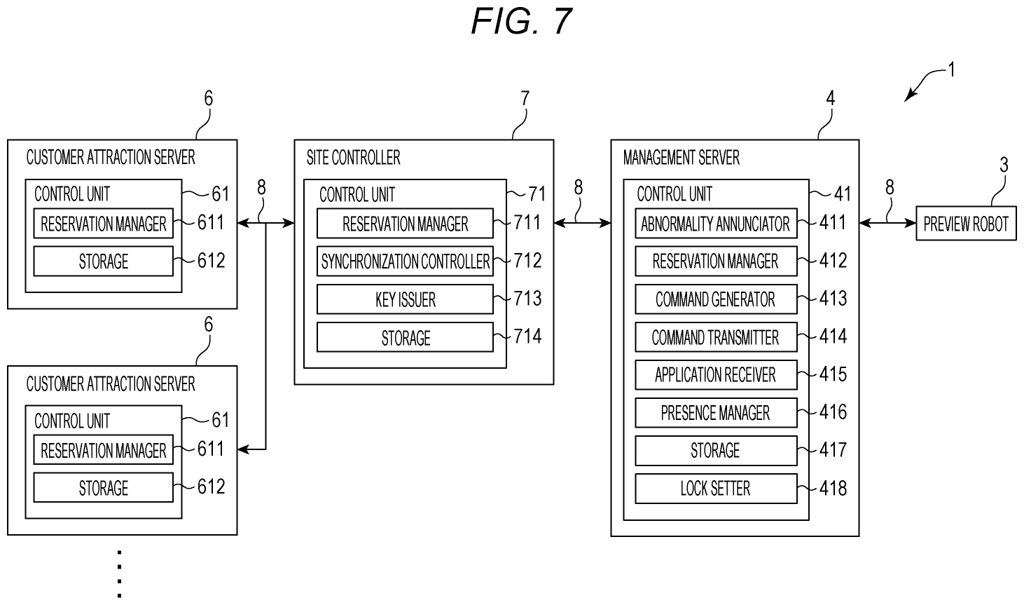

FIG. 7 is a functional block diagram illustrating the management server, the customer attraction server, and the site controller in the schematic configuration of the building monitoring system.

The customer attraction server 6 includes a control unit 61 as a customer attraction server side control unit.

The control unit 61 includes the CPU, the memory, and the like, and executes information processing according to the predetermined program stored in the memory. The control unit 61 includes a reservation manager 611 as a customer attraction side reservation manager and a storage 612.

The reservation manager 611 causes the storage 612 to store customer attraction side reservation information including the preview start time and the preview end time set by the reservation, and manages the customer attraction side reservation information.

The site controller 7 functions as an information processing device for setting the preview time and allowing the previewer to use the room 20, and includes a control unit 71 as an information processing device side control unit.

The control unit 71 includes the CPU, the memory, and the like, and executes information processing according to the predetermined program stored in the memory. The control unit 71 includes a reservation manager 711, a synchronization controller 712, a key issuer 713, and a storage 714.

The reservation manager 711 causes the storage 714 to store information processing device side reservation information including the preview start time and the preview end time set by the reservation, and manages the information processing device side reservation information.

The synchronization controller 712 synchronizes the reservation information (the management side reservation information and the customer attraction side reservation information) between the management server 4 and the customer attraction server 6.

The key issuer 713 issues the unlocking key corresponding to the locking device 22 of the room 20 in each building 2.

Note that the storages 612 and 714 include the memories of the control units 61 and 71, but may include the HDD, the NAS, or the like, and may include the cloud service.

Further, although functions of the control units 61 and 71 are executed according to programs stored in the storages 612 and 714, each function may be implemented by the independent device or may be implemented by cloud computing.

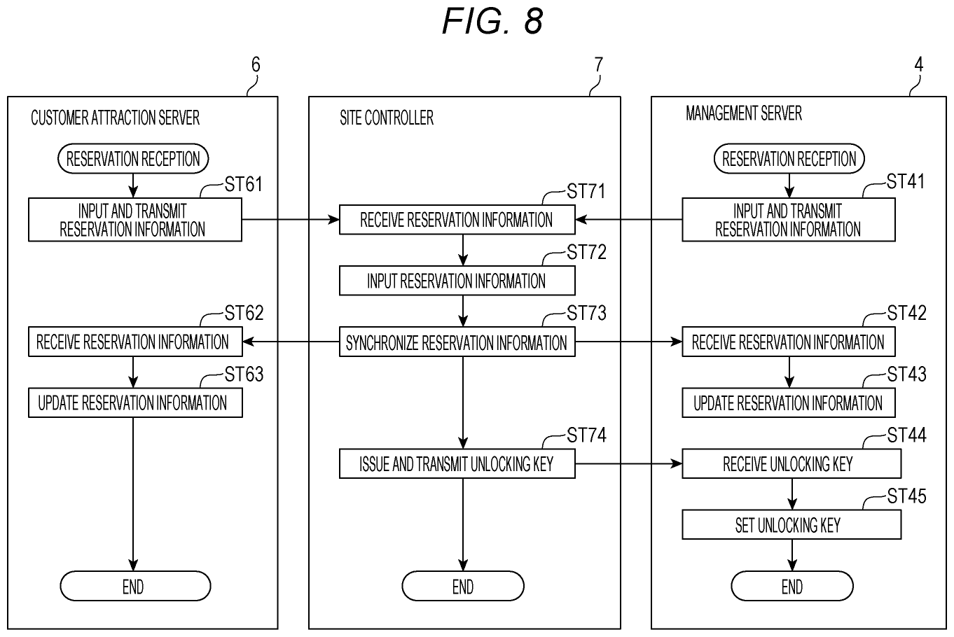

FIG. 8 is a flowchart illustrating operations of the management server, the customer attraction server, and the site controller.

As illustrated in FIG. 8, the control units 41, 61, and 71 of the management server 4, the customer attraction server 6, and the site controller 7 perform various processing of Steps ST41 to ST45, ST61 to ST63, ST71 to ST74 according to the predetermined program stored in the memory.

As described above, the previewer can access the management server 4 or the customer attraction server 6 via the Internet 8 using the terminal device 5, search for the room 20 desired for the preview, and make a reservation for the preview by specifying the preview time.

Note that in the present embodiment, the previewer can access the management server 4 or the customer attraction server 6 via the Internet 8 using the terminal device 5, search for the room 20 desired for the preview, and make a reservation for the preview by specifying the usage time, but it may be configured so that only one of the management server 4 and the customer attraction server 6 can make a reservation for the preview.

Upon receiving the reservation from the previewer, the reservation manager 412 of the management server 4 inputs and stores the management side reservation information including the previewer and the reservation date and time of the room 20 for which the reservation has been confirmed in the storage 417, and transmits the management side reservation information to the site controller 7 via the Internet 8 (Step ST41).

Further, upon receiving the reservation from the previewer, the reservation manager 611 of the customer attraction server 6 inputs and stores the customer attraction side reservation information including the previewer and the reservation date and time of the room 20 for which the reservation has been confirmed in the storage 612, and transmits the customer attraction side reservation information to the site controller 7 via the Internet 8 (Step ST61).

When the reservation information is transmitted from the management server 4 or the customer attraction server 6, the reservation manager 711 of the site controller 7 receives the reservation information (Step ST71).

Upon receiving the reservation information from the management server 4 or the customer attraction server 6, the reservation manager 711 of the site controller 7 inputs and stores the reservation information as the information processing device side reservation information in the storage 714 (Step ST72). In other words, the reservation manager 711 functions as an information obtainer that obtains update of the customer attraction side reservation information of the customer attraction server 6 and update of the management side reservation information of the management server 4.

Then, the synchronization controller 712 of the site controller 7 transmits the information processing device side reservation information stored in the storage 714 to the management server 4 and the customer attraction server 6, and synchronizes the reservation information between the management server 4 and the customer attraction server 6. (Step ST73).

Upon receiving the reservation information from the site controller 7 (Step ST42), the reservation manager 412 of the management server 4 inputs and stores the reservation information as the management side reservation information in the storage 417, thereby updating the management side reservation information stored in the storage 417 (Step ST43).

Further, upon receiving the reservation information from the site controller 7 (Step ST62), the reservation manager 611 of the customer attraction server 6 inputs and stores the reservation information as the customer attraction side reservation information in the storage 612, thereby updating the customer attraction side reservation information stored in the storage 612 (Step ST63).

By performing the above steps, the reservation information stored in the management server 4 and all the customer attraction servers 6 match.

After transmitting the information processing device side reservation information stored in the storage 714 to the management server 4 and the customer attraction server 6, the key issuer 713 of the site controller 7 issues the unlocking key corresponding to the locking device 22 of the room 20 related to the information processing device side reservation information, and transmits the unlocking key to the management server 4, and the terminal device 5 of the previewer in association with the information processing device side reservation information (Step ST74). In other words, the key issuer 713 issues the unlocking key for unlocking the locking device 22 of the room 20 when the reservation manager 711 obtains the update of the customer attraction side reservation information.

Upon receiving the unlocking key from the site controller 7 (Step ST44), the reservation manager 412 of the management server 4 stores the unlocking key as the unlocking key corresponding to the management side reservation information stored in the storage 417 on the basis of the information processing device side reservation information associated with the unlocking key.

Then, the lock setter 418 of the management server 4 sets the unlocking key corresponding to the management side reservation information to the locking device 22 of the room 20, when the preview start time included in the management side reservation information is reached, or shortly before the preview start time (for example, 10 minutes before the preview start time) (Step ST45). Thus, the previewer can unlock the locking device 22 of the room 20 by using the unlocking key transmitted from the site controller 7 and enter the room 20.

The lock setter 418 of the management server 4 sets an unlocking key different from the unlocking key corresponding to the management side reservation information to the locking device 22 of the room 20, when the preview end time included in the management side reservation information has passed, or a little after the preview end time (for example, 10 minutes after the preview end time). This prevents the previewer from re-entering the room 20.

According to such an embodiment, the following operations and effects can be obtained.

(1) The control unit 34 includes the abnormality notifier 341 that notifies the management server 4 of the abnormality via the Internet 8 when the abnormality having occurred inside the building 2 is detected, and the control unit 41 includes the abnormality annunciator 411 that announces the abnormality to the administrator when it is notified of the abnormality by the abnormality notifier 341, so that the administrator can easily grasp the abnormality such as damage inside the building 2 even when the building 2 is previewed without the presence of the agent. Therefore, according to the building monitoring system 1, it is possible to monitor the building 2 unattended without requiring the presence of the agent, and to suppress the damage or the like inside the building 2.

(2) The control unit 34 includes the locking device determiner 342 that determines whether the locking device 22 has been normally unlocked, and detects the abnormality having occurred inside the building 2 when the locking device determiner has determined that the locking device 22 has not been normally unlocked, so that for example, unlike the previewer who can unlock the locking device 22 normally, that is, the previewer authorized by the administrator, intrusion of an unauthorized person using an illegal means such as picking can be detected as the abnormality by the locking device determiner 342, and safety of the building 2 can be improved.

(3) The control unit 34 includes the customer service executor 343 that executes customer service by the touch panel 32 when the locking device determiner 342 determines that the locking device 22 is normally unlocked, so that it is possible to execute customer service by the touch panel 32 to the previewer who can unlock the locking device 22 normally, that is, the previewer authorized by the administrator.

(4) The control unit 34 includes the behavior pattern determiner 345 that compares the sample of the normal behavior pattern of the previewer of the building 2 with the behavior pattern obtained by the behavior pattern obtainer and determines whether there is a difference, and detects the abnormality having occurred inside the building 2 when the behavior pattern determiner has determined that there is a difference, so that it is possible to detect by the behavior pattern determiner 345 as the abnormality an intruder with a suspicious behavior pattern such as looking for the inside of the building 2, and to improve the safety of the building 2.

(5) The control unit 34 includes the command receiver 346 that receives the command from the command transmitter 414, and the command executor 347 that executes the predetermined operation on the basis of the command received by the command receiver 346, so that it is possible to reach out to the previewer who is looking around the inside of the building 2 by executing an operation based on an appropriate command.

(6) Since the command executor 347 announces the preview end time to the previewer on the basis of the announcement command, the preview robot 3 can suppress time excess of the preview by announcing the preview end time to the previewer, set free time until reservation of a next previewer to be short, and improve efficiency of previewing the building 2.

(7) Since the command executor 347 announces to the previewer whether the preview time can be extended on the basis of the extension command, when there is free time in the reservation after the preview end time, it is possible to announce to the previewer that the preview time can be extended. In addition, when there is no free time in the reservation after the preview end time, it is possible to announce to the previewer that the preview time cannot be extended.

(8) The control unit 41 includes the application receiver 415 that receives the application for extension transmitted from the application transmitter 348, and the reservation manager 412 changes the preview end time and updates the management side reservation information on the basis of the application for extension received by the application receiver 415, so that the preview time can be extended on the basis of the application for extension by the previewer.
(9) The command generator 413 generates the warning command to announce the warning to the previewer when the previewer is present even after the preview end time on the basis of the management side reservation information and the presence information, and the command executor 347 announces to the previewer that the preview end time has passed on the basis of the warning command, so that it is possible to reliably announce the time excess of the preview to the previewer.

(10) The site controller 7 is connected to the management server 4 and the customer attraction server 6 via the Internet 8, obtains by the reservation manager 711 the update of the customer attraction side reservation information of the customer attraction server 6 received via the terminal device 5, and the update of the management side reservation information of the management server 4, and can synchronize the management side reservation information and the customer attraction side reservation information by the synchronization controller 712, so that it is possible to prevent double booking of the reservation for the room 20, and to increase certainty of the reservation. Further, since the management server 4 and the customer attraction server 6 do not need to synchronize the reservation information with each other, loads on these servers can be suppressed.

(11) Since the site controller 7 includes the key issuer 713 that issues the unlocking key for unlocking the locking device 22 of the room 20 on the basis of the update of the customer attraction side reservation information, it is possible to issue the unlocking key to the previewer even for the reservation from the customer attraction server 6 that does not meet the specifications of the locking device 22 of the room 20, and to widely attract previewers regardless of the specifications of the customer attraction server 6.

[Modification of Embodiment] The present disclosure is not limited to the above-described embodiment, and modifications, improvements, and the like within a range in which an object of the present disclosure can be achieved are included in the present disclosure.

For example, in the above embodiment, various functions of the building monitoring system 1 are distributed and implemented in the preview robot 3, the management server 4, the customer attraction server 6, and the site controller 7, but any function may be distributed and implemented in any of the preview robot 3, the management server 4, the customer attraction server 6, and the site controller 7, and the building monitoring system 1 may be appropriately designed as long as the various functions of the building monitoring system 1 can be implemented. For example, in the above embodiment, the locking device 22 is connected to the preview robot 3 via the Internet 8, but may not be connected to the preview robot 3 via the Internet 8. In this case, the locking device determiner is only required to be implemented in the management server 4.

In the above embodiment, the management server 4, the customer attraction server 6, and the site controller 7 may be configured by a centralized management type server device or may be a distributed management type, for example, a device using a distributed transaction ledger typified by blockchain can be used, and the management server 4 is only required to be able to manage the management side reservation information, send various commands to the preview robot 3, and receive and process the application from the preview robot 3.

Further, in the above embodiment, the management server 4, the customer attraction server 6, and the site controller 7 are separately provided and connected to each other via the Internet 8, but the present disclosure is not limited to this, and the management server 4, the customer attraction server 6, and the site controller 7 may be provided in a single site, or functions of the management server 4, the customer attraction server 6, and the site controller 7 may be implemented by a plurality of devices distributed on the Internet 8.

In the above embodiment, the control unit 34 includes the behavior pattern determiner 345 that compares the sample of the normal behavior pattern of the previewer of the building 2 with the behavior pattern obtained by the behavior pattern obtainer and determines whether there is a difference, and detects the abnormality having occurred inside the building 2 when the behavior pattern determiner has determined that there is a difference. On the other hand, for example, the building monitoring device side control unit may include the behavior pattern determiner that compares a sample of an abnormal behavior pattern of the previewer of the building with the behavior pattern obtained by the behavior pattern obtainer and determines whether the sample of an abnormal behavior pattern and the obtained behavior pattern match, and detects the abnormality having occurred inside the building when the behavior pattern determiner has determined that the sample of an abnormal behavior pattern and the obtained behavior pattern match. In this case, the storage is only required to store, as the abnormal behavior pattern, the suspicious behavior pattern such as looking for the inside of the building.

In the above embodiment, the command generator 413 generates the extension command that announces whether the preview time can be extended according to the reservation status of the room 20, and the command executor 347 of the preview robot 3 announces to the previewer whether the preview time can be extended, but a function of announcing whether the preview time can be extended can be omitted. Further, in the above embodiment, the preview robot 3 includes the touch panel 32 that receives the input of the application for extension from the previewer, and the application transmitter 348 that transmits the application for extension to the management server 4, and the management server 4 includes the application receiver 415 that receives the application for extension, but functions of inputting and transmitting and receiving such an application for extension can be omitted. Further, the functions related to the announcement and the application for extension may be executed by using the terminal device 5 of the previewer via the customer attraction server 6 or the site controller 7.

In the above embodiment, the command generator 413 generates the warning command for announcing the warning to the previewer when the previewer is present even after the preview end time, and the command executor 347 of the preview robot 3 announces the previewer that the preview end time has passed, but the function of announcing such a time excess can be omitted. Further, the function of announcing the time excess may be executed by using the terminal device 5 of the previewer via the customer attraction server 6 or the site controller 7.

In the above embodiment, the information processing device of the present disclosure is described by taking the preview of the building in real estate brokerage business as an example, but the information processing device of the present disclosure can increase certainty of reservation while suppressing a load on the management server regardless of how the building is used. For example, the information processing device of the present disclosure can be applied to a rental room to be rented for multiple purposes by setting the usage time, or a building that is used for the store or the like that displays the products or the like in the building.

In the above embodiment, the site controller 7 constitutes a part of the building monitoring system 1, but it does not have to constitute a part of the building monitoring system 1. In short, the information processing device is only required to be a device that is connected to the management server for managing information on a building and at least one customer attraction server for attracting the user of the building via the communication line, and sets the usage time and allows the user to use the building.

1. An information processing device that is connected to a management server for managing information on a building and at least one customer attraction server for attracting a user of the building via a communication line, and sets a usage time and allows the user to use the building, wherein
the customer attraction server comprises a customer attraction server side control means that controls the customer attraction server,
the customer attraction server side control means comprises a customer attraction side reservation manager that is connected to a user input means for receiving information input to the customer attraction server via the communication line, and manages customer attraction side reservation information regarding the user received via the user input means and reservation date and time including usage start time and usage end time set by reservation,
the management server comprises a management server side control means that controls the management server,
the management server side control means comprises a management side reservation manager that manages management side reservation information regarding the user and the reservation date and time including the usage start time and the usage end time set by the reservation,
the information processing device comprises an information processing device side control means that controls the information processing device, and
the information processing device side control means comprises:
an information obtainer that obtains update of the customer attraction side reservation information of the customer attraction server and update of the management side reservation information of the management server; and
a synchronization controller that synchronizes the customer attraction side reservation information of the customer attraction server and the management side reservation information of the management server on the basis of the customer attraction side reservation information and the management side reservation information obtained by the information obtainer.

2. The information processing device according to claim 1, comprising a key issuer that issues an unlocking key for unlocking a locking device of the building when the update of the customer attraction side reservation information is obtained.

3. A building monitoring system comprising:
the information processing device according to claim 1;
a building monitoring device that is provided inside a building and monitors an inside of the building; and
the management server that is connected to the building monitoring device via the communication line and manages the building monitoring device, wherein
the building monitoring device comprises a building monitoring device side control means that controls the building monitoring device,
the building monitoring device side control means comprises an abnormality notifier that notifies the management server of an abnormality via the communication line when the abnormality having occurred inside the building is detected, and
the management server side control means comprises an abnormality annunciator that announces the abnormality to an administrator when the abnormality is notified of by the abnormality notifier.

4. The building monitoring system according to claim 3, wherein
the building monitoring device is connected to a locking device of the building via a communication line, and
the building monitoring device side control means comprises a locking device determiner that determines whether the locking device has been normally unlocked, and detects the abnormality having occurred inside the building when the locking device determiner has determined that the locking device has not been normally unlocked.

5. The building monitoring system according to claim 4, wherein
the building monitoring device comprises a customer service means that serves the user of the building, and
the building monitoring device side control means comprises a customer service executor that executes customer service by the customer service means when the locking device determiner determines that the locking device is normally unlocked.

6. The building monitoring system according to claim 3, wherein
the building monitoring device comprises an image capturing means that captures an image of the inside of the building, and
the building monitoring device side control means comprises:
a storage that stores a sample of a normal behavior pattern of the user of the building;
a behavior pattern obtainer that obtains the behavior pattern of the user of the building on the basis of the image captured by the image capturing means; and
a behavior pattern determiner that compares the sample of the behavior pattern stored in the storage with the behavior pattern obtained by the behavior pattern obtainer, determines whether there is a difference, and detects the abnormality having occurred inside the building when the behavior pattern determiner has determined that there is the difference.

7. The building monitoring system according to claim 3, wherein
the building monitoring device comprises an image capturing means that captures an image of the inside of the building, and
the building monitoring device side control means comprises:
a storage that stores a sample of an abnormal behavior pattern of the user of the building;
a behavior pattern obtainer that obtains the behavior pattern of the user of the building on the basis of the image captured by the image capturing means; and
a behavior pattern determiner that compares the sample of the behavior pattern stored in the storage with the behavior pattern obtained by the behavior pattern obtainer, determines whether the sample of the behavior pattern and the obtained behavior pattern match, and detects the abnormality having occurred inside the building when the behavior pattern determiner has determined that the sample of the behavior pattern and the obtained behavior pattern match.

8. The building monitoring system according to claim 3, wherein
the management server side control means comprises:
a management side reservation manager that manages management side reservation information including usage start time and usage end time set by reservation;
a command generator that generates a command to the building monitoring device on the basis of the management side reservation information; and
a command transmitter that transmits the command to the building monitoring device via the communication line, and
the building monitoring device side control means comprises:
a command receiver that receives the command from the command transmitter; and
a command executor that executes a predetermined operation on the basis of the command received by the command receiver.

9. The building monitoring system according to claim 8, wherein
the command generator generates an announcement command to announce the usage end time on the basis of the management side reservation information, and
the command executor announces the usage end time to the user on the basis of the announcement command.

10. The building monitoring system according to claim 8, wherein
the management side reservation manager manages the management side reservation information including a reservation status after the usage end time,
the command generator generates an extension command to announce whether the usage time can be extended according to the reservation status on the basis of the management side reservation information, and
the command executor announces to the user whether the usage time can be extended on the basis of the extension command.

11. The building monitoring system according to claim 10, wherein
the building monitoring device comprises an input receiving means that receives input of an application for extension by a user,
the building monitoring device side control means comprises an application transmitter that transmits the application for extension to the management server via the communication line when the input of the application for extension is received by the input receiving means,
the management server side control means comprises an application receiver that receives the application for extension transmitted from the application transmitter, and
the management side reservation manager changes the usage end time and updates the management side reservation information on the basis of the application for extension received by the application receiver.

12. The building monitoring system according to claim 8, wherein
the building monitoring device comprises a presence detection means that detects presence of a user inside the building,
the building monitoring device side control means comprises a presence notifier that notifies the management server of the presence of the user via the communication line when the presence detection means detects the presence of the user,
the management server side control means comprises a presence manager that manages presence information of the user notified by the presence notifier,
the command generator generates a warning command to announce a warning to the user when the user is present even after the usage end time on the basis of the management side reservation information and the presence information, and
the command executor announces to the user that the usage end time has passed on the basis of the warning command.
